(19) United States
(12) Patent Application Publication
(10) Pub. No.: US 2025/0229668 A1
(43) Pub. Date: Jul. 17, 2025

(54) DUAL-DESIGN BATTERY MODULE AND CONTROL SYSTEM FOR LONG RANGE VEHICLE APPLICATION

(71) Applicant: GM GLOBAL TECHNOLOGY OPERATIONS LLC, Detroit, MI (US)

(72) Inventors: Jun-mo Kang, Ann Arbor, MI (US); Shuonan Xu, Troy, MI (US)

(73) Assignee: GM GLOBAL TECHNOLOGY OPERATIONS LLC, Detroit, MI (US)

(21) Appl. No.: 18/413,824

(22) Filed: Jan. 16, 2024

(51) Int. Cl. B60L 58/22; B60L 58/12

(52) U.S. Cl. CPC B60L 58/22; B60L 58/12; B60L 2210/12; B60L 2210/14; B60L 2240/545

(57) ABSTRACT

A system for managing an energy storage device in a vehicle includes a battery module having an energy pack, and a power pack connected in parallel to the energy pack. A controller is adapted to determine a minimum state of charge for the respective battery cells in the power pack, such that a respective voltage of the power pack is equal to the respective voltage of the energy pack. The power pack is a sole power source for the vehicle during a first stage, with the power pack being discharged during the first stage until the minimum SOC is reached. The energy pack and the power pack concurrently provide power to the vehicle during the second stage. Operation of the vehicle is controlled based in part on the minimum SOC, with the controller being adapted to maintain the minimum SOC for the power pack during the second stage.

### INTRODUCTION

The present disclosure relates generally to management of a dual-design battery module for long range applications. The use of mobile platforms employing a rechargeable energy source, both as an exclusive source of energy and a non-exclusive source of energy, has greatly increased over the last few years. An energy storage device with battery modules may store and release electrochemical energy as needed during a given operating mode. The electrochemical energy may be employed for propulsion, heating or cooling a cabin compartment, powering vehicle accessories and other uses. The various cells in the battery modules may be characterized by different charge states, power, and capacity rates. In a battery module with a complex structure, management of the various parameters may be challenging.

### SUMMARY

Disclosed herein is a system for managing an energy storage device in a vehicle. The system includes a battery module having an energy pack adapted to generate a first current, and a power pack connected in parallel to the energy pack. At least one DC-DC (direct current to direct current) converter is adapted to receive the first current from the energy pack and transmit a DC-DC current to the power pack. The system includes a controller having a processor and tangible, non-transitory memory on which instructions are recorded. Execution of the instructions causes the controller to determine a minimum SOC (state of charge) for the respective battery cells in the power pack, based in part on a plurality of parameters, such that a respective voltage of the power pack is equal to the respective voltage of the energy pack.

The vehicle is adapted to undergo a first stage and a second stage. The power pack is discharged during the first stage until the minimum SOC is reached, with the power pack being a sole power source for the vehicle during the first stage. The energy pack and the power pack are adapted to concurrently provide power to the vehicle during the second stage. Operation of the vehicle is controlled based in part on the minimum SOC, with the controller being adapted to maintain the minimum SOC for the power pack during the second stage through the DC-DC current from the energy pack to the power pack.

The power pack is adapted to deliver a load current for powering a load in the vehicle. The plurality of parameters may include an expected maximum value of the load current, a state of charge of the energy pack, and a temperature of the battery module. In some embodiments, the DC-DC converter includes an exclusive buck mode and an exclusive boost mode. The DC-DC converter operates in the exclusive boost mode when the respective battery cells in the energy pack are discharging, and the DC-DC converter operates in the exclusive buck mode when the respective battery cells in the energy pack are charging.

The controller may be adapted to exit the first stage when a predefined event of relatively high-power demand occurs, e.g., a power boost is needed. The terminal voltage of the respective battery cells in the energy pack is lower than the terminal voltage of the respective battery cells in the power pack. In some embodiments, the energy pack and the power pack have different chemistries. The respective battery cells in the energy pack may be at least partially composed of nickel, cobalt oxide, and manganese. The respective battery cells in the power pack may be at least partially composed of lithium, iron, and phosphate.

Disclosed herein is a method for managing an energy storage device in a vehicle having a controller with a processor and tangible, non-transitory memory, the energy storage device having a battery module. The method includes incorporating an energy pack and a power pack in the battery module, the energy pack and the power pack being connected in parallel. The method includes generating a first current, via the energy pack. The method includes adapting at least one DC-DC (direct current to direct current) converter to receive the first current from the energy pack and transmit a DC-DC current to the power pack. The method includes determining a minimum SOC (state of charge) for respective battery cells in the power pack, based in part on a plurality of parameters, such that a respective voltage of the power pack is equal to the respective voltage of the energy pack.

The vehicle is adapted to undergo a first stage and a second stage, the energy pack and the power pack being adapted to concurrently provide power to the vehicle during the second stage. The method includes discharging the power pack during the first stage until the minimum SOC is reached, the power pack being a sole power source for the vehicle during the first stage. The method includes controlling operation of the vehicle based in part on the minimum SOC. The controller is adapted to maintain the minimum SOC for the power pack during the second stage through the DC-DC current from the energy pack to the power pack.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a system for managing an energy storage device, the system having a controller and a battery module;

FIG. 2 is a schematic diagram of an example modular architecture employable by the system of FIG. 1;

FIG. 3 is a schematic flow diagram of a method executable by the controller of FIG. 1;

FIG. 4 is a schematic example graph illustrating voltage on the vertical axis and state of charge on the horizontal axis for an example battery module; and

FIG. 5 shows schematic example graphs illustrating various parameters of an example battery module.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

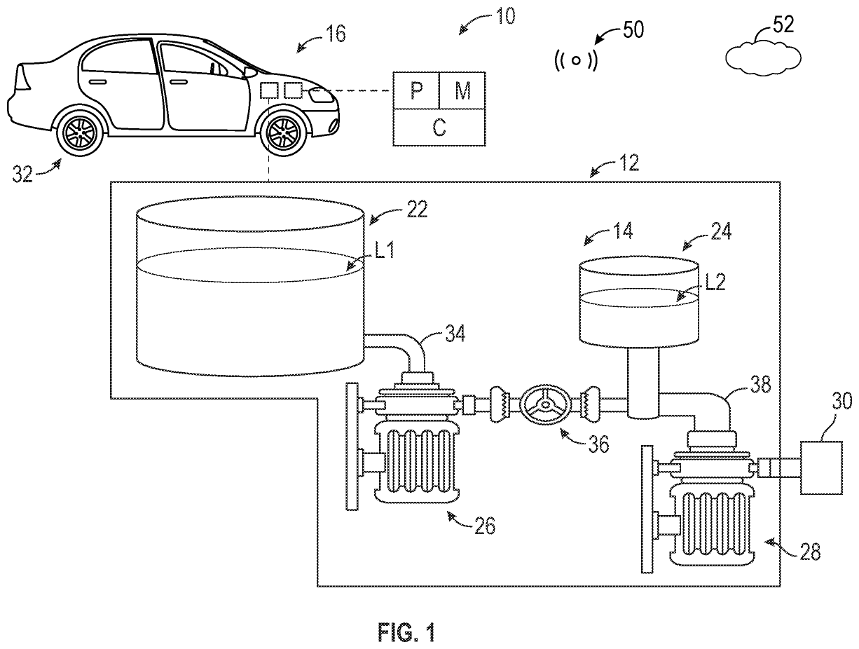

Referring to the drawings, wherein like reference numbers refer to like components, FIG. 1 is a schematic diagram illustrating a system 10 for managing an energy storage device 12. The energy storage device 12 in FIG. 1 is schematically presented as a hydraulic system for illustrative purposes. However, it is to be understood that the energy storage device 12 is a battery system having a battery module 14. The battery module 14 features a “dual design” system in that it employs both energy battery cells and power battery cells.

Referring to FIG. 1, the energy storage device 12 may be part of a vehicle 16. The vehicle 16 may be partially electric or fully electric. The vehicle 16 may be a mobile platform, such as, but not limited to, a passenger vehicle, sport utility vehicle, light truck, heavy duty vehicle, ATV, minivan, bus, transit vehicle, bicycle, moving robot, farm implement (e.g., tractor), sports-related equipment (e.g., golf cart), boat, aircraft and train. It is to be understood that the vehicle 16 may take many different forms and have additional components.

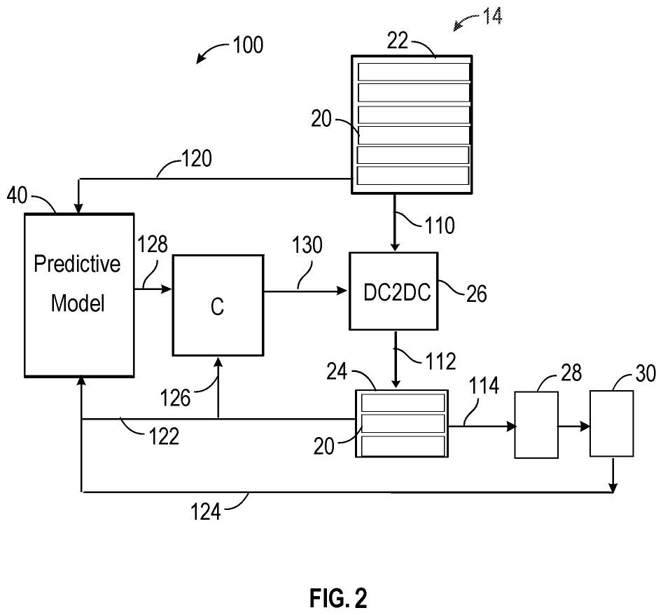

As described below, the range of the vehicle 16 may be extended through optimal energy management of the battery module 14. FIG. 2 is a schematic diagram of an example modular architecture 100 employable by the system 10. Referring to FIGS. 1-2, the battery module 14 includes respective battery cells 20 arranged in an energy pack 22 and a power pack 24. The power pack 24 is parallel to the energy pack 22. The power pack 24 supplies more power than the energy pack 22. The energy pack 22 supplies consistent power for a longer duration than the power pack 24. The number of respective battery cells 20 in the energy pack 22 and power pack 24 may be varied based on the application at hand.

The design and/or composition of the power pack 24 allows rapid movement of ions into and out of the electrode, thereby generating a higher power output. The design and/or composition of the energy pack 22 reduces the movement of ions into and out of the electrode, thereby limiting power output. In other words, the energy pack 22 is adapted to provide a sustained current for a longer period compared with the power pack 24, and the power pack 24 may provide a higher current over a short duration as compared with the energy pack 22.

In one embodiment, the respective battery cells 20 in the power pack include an electrode formed from a porous material and a thinner coating, while the respective battery cells 20 in the energy pack include an electrode formed from a denser material and a thicker coating. In one embodiment, the voltage of the energy pack 22 is about 800 volts and the voltage of the power pack 24 is between about 400 volts to 600 volts.

The energy pack 22 and the power pack 24 may employ batteries based on different chemistries. For example, the energy pack 22 may include battery cells, referred to herein as energy cells, with the cathode material composed of nickel, cobalt oxide, and manganese. It is understood that the battery cells may be composed of other suitable materials available to those skilled in the art. The battery cells in the energy pack 22, referred to herein as energy cells, are long-range cells having higher specific energy but with a relatively shorter cycle life.

The power pack 24 may include battery cells with the cathode material composed of lithium, iron, and phosphate. The battery cells in the power pack 24, referred to herein as power cells, are short-range cells having lower specific energy but with a relatively longer cycle life. It is understood that the system 10 is not tied to a particular cell type, chemistry, and configuration of the battery module 14. In another embodiment, the energy pack 22 and the power pack 24 employ different battery designs, with the same chemistry.

Referring to FIGS. 1-2, the power pack 24 is adapted to provide on-demand power (via a traction inverter 28) for powering a load, such as an electric motor 30 in the vehicle 16. The traction inverter 28 converts the DC power from the battery module 14 to an AC output for running the electric motor 30. When the vehicle 16 is in operation, the battery module 14 is controlled by the controller C to generate (ultimately) and deliver motor torque to the wheels 32 and thus propel the vehicle 16.

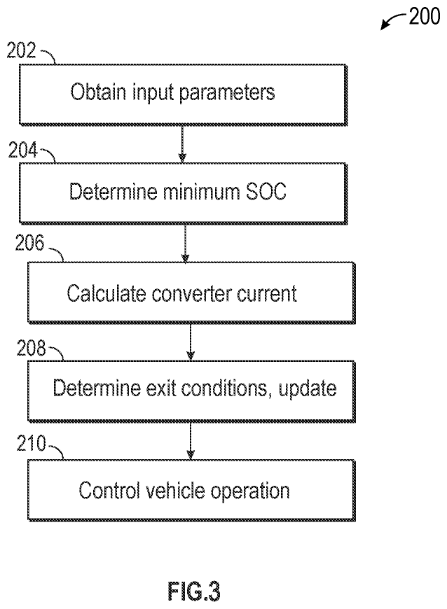

Referring to FIG. 1, the system 10 includes a controller C with at least one processor P and at least one memory M (or non-transitory, tangible computer readable storage medium) on which instructions are recorded for executing a method 200 for managing the battery module 14, described below with respect to FIG. 3. The memory M can store executable instruction sets, and the processor P can execute the instruction sets stored in the memory M.

As described below, controller C is adapted to determine a threshold or minimum state of charge (“SOC”) of the power pack 24, based on real-time measurements and/or estimations of temperature, maximum load current and the state of charge of energy pack 22. The system 10 employs a control strategy that maintains the state of charge of the power pack 24 at or above the minimum SOC. The method 200 enables a relatively longer range for the vehicle 16. In one example, a long range may be considered as the vehicle 16 travelling about 300 miles without being recharged. The technical advantages further include extension of the cycle life of the energy pack 22 through using the power pack 24 for short trips.

Referring to FIGS. 1-2, the energy pack 22 is adapted to generate a first current 110. The energy storage device 12 includes at least one direct current to direct current (DC-DC) converter 26 adapted to receive the first current 110 (see FIG. 2) from the energy pack 22. The DC-DC converter 26 is adapted to transmit a current, referred to herein as DC-DC current 112, to the power pack 24. The power pack 24 is adapted to deliver a second current 114.

The maximum and minimum current that may be respectively taken from the power pack 24 and energy pack 22 varies over time as their respective charging status shifts. FIG. 1 schematically indicates the state of charge of the power pack 24 and energy pack 22 as levels L1 and L2, respectively. The levels L1 and L2 of the power pack 24 and energy pack 22 should be neither overfilled, nor drained. Referring to FIG. 1, the maximum current flow transmitted by the energy pack 22 into the DC-DC converter 26 may be limited by a first conduit 34. A user may limit the current flow going into the power pack 24 through a selector 36. Similarly, the maximum current flow transmitted by the power pack 24 into the traction inverter 28 may be limited by a second conduit 38.

Referring to FIG. 2, the DC-DC converter 26 includes an exclusive buck mode and an exclusive boost mode. The DC-DC converter 26 operates in the exclusive boost mode when the respective battery cells 20 in the energy pack 22 are discharging. The DC-DC converter 26 operates in the exclusive buck mode when the respective battery cells 20 in the energy pack 22 are charging. In the exclusive buck mode, the DC-DC converter 26 steps down the input voltage. In the exclusive boost mode, the DC-DC converter 26 steps up the input voltage.

The battery module 14 is configured such that the terminal voltage of the respective battery cells in the energy pack 22 is lower than the terminal voltage of the respective battery cells in the power pack 24. The controller C manages individual energies from the power pack and the energy pack to meet power demand while meeting strict constraints to preserve the battery module 14 and DC-DC converter 26 in real-time.

Referring now to FIG. 3, a flowchart of the method 200 stored on and executable by the controller C of FIG. 1 is shown. Method 200 may be embodied as computer-readable code or instructions stored on and partially executable by the controller C of FIG. 1. Method 200 need not be applied in the specific order recited herein. Furthermore, it is to be understood that some steps may be eliminated. The method 200 may be dynamically executed.

Per block 202 of FIG. 3, the method 200 includes obtaining a plurality of parameters, including a state of charge of the energy pack 22, a temperature of the battery module 14, and an expected maximum value of the load current. The power pack 24 is adapted to deliver a load current for powering a load in the vehicle 16. Referring to FIG. 2, the modular architecture 100 may include a predictive model 40 that receives state of charge feedback (indicated by line 120) from the energy pack 22, predicted or expected maximum load current (indicated by line 122) from the power pack 24, and temperature input (indicated by line 124) from the propulsion system. The controller C is adapted to receive state of charge feedback (indicated by line 126) from the power pack 24.

Proceeding to block 204, the controller C is adapted to determine a minimum SOC threshold of the power pack 24 in real-time based on the plurality of parameters, such that a respective voltage of the power pack 24 is equal to the respective voltage of the energy pack 22.

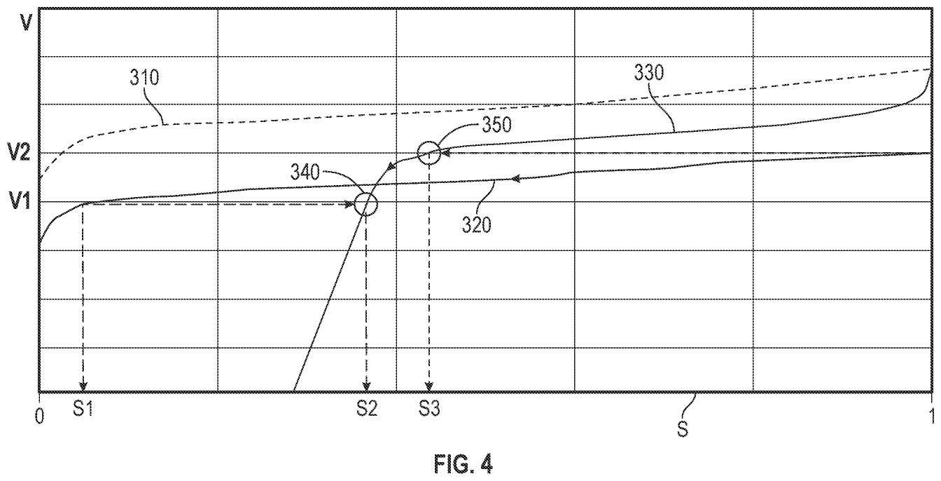

FIG. 4 is a schematic example graph illustrating voltage V on the vertical axis, and state of charge S on the horizontal axis, at a temperature of about 20 degrees Celsius. Referring to FIG. 4, trace 310 illustrates the open circuit voltage (OCV) of the power pack 24, and trace 320 illustrates the OCV of the energy pack 22. Trace 330 shows the load current for the power pack 24. The first junction 340 in FIG. 4 indicates a point where the power pack 24 and the energy pack 22 both are at a first voltage V1. The first voltage V1 corresponds to a state of charge S1 of the energy pack 22, and a state of charge S2 of the power pack 24. Here the state of charge S2 would be the minimum SOC for the power pack 24. In one example, the first state of charge S1 is 0.05. The second junction 350 in FIG. 4 indicates a point where the power pack 24 and the energy pack 22 both are at a second voltage V2, which corresponds to state of charge of 100% of the energy pack 22 and a state of charge S3 of the power pack 24. Here the state of charge S3 would be the minimum SOC for the power pack 24.

Advancing to block 206, the controller C (via execution of the predictive model 40) is adapted to calculate a converter current (or DC-DC current) required to maintain the minimum SOC of the power pack 24 in real-time. The controller C may employ methods available to those skilled in the art. Referring to FIG. 2, the predictive model 40 outputs a real-time minimum SOC threshold (indicated by line 128) to the controller C, which subsequently outputs a corresponding DC-DC current (indicated by line 130) for the DC-DC converter 26 to maintain the minimum SOC in real-time.

As noted above, the DC-DC converter 26 includes an exclusive buck mode and an exclusive boost mode. The DC-DC converter 26 operates in the exclusive boost mode when the respective battery cells 20 in the energy pack 22 are discharging, and the DC-DC converter 26 operates in the exclusive buck mode when the respective battery cells 20 in the energy pack 22 are charging.

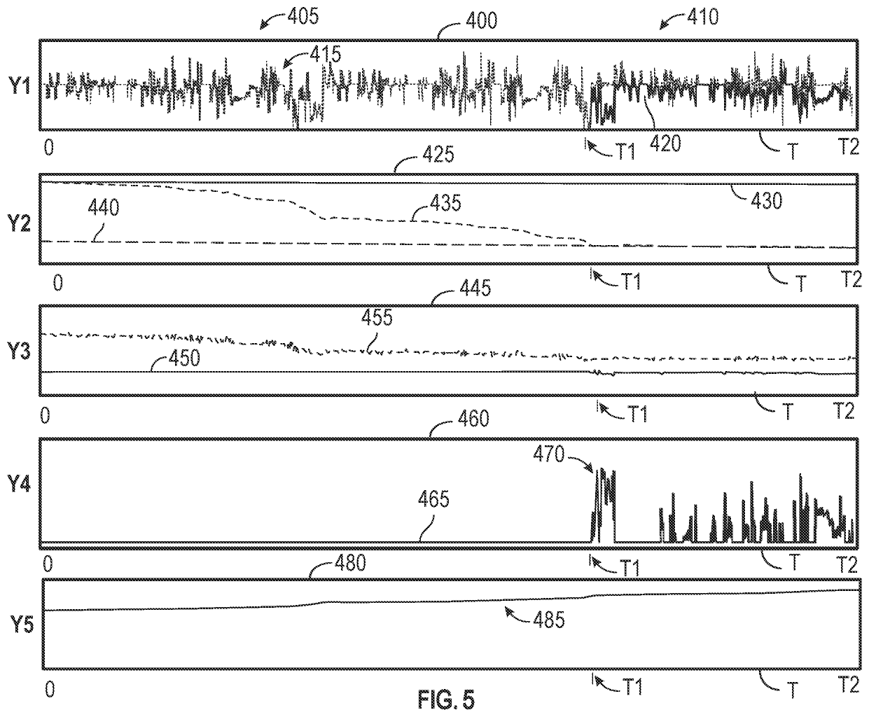

FIG. 5 shows schematic example graphs illustrating various parameters, for an example battery module 14 in a vehicle 16. Referring to box 400 in FIG. 5, the vertical axis Y1 indicates current (in amperes), and the horizontal axis T shows time. The time period that is shown in FIG. 5 is subdivided into a first stage 405 (between time zero and time T1), and a second stage 410 (between time T1 and time T2). Trace 415 and trace 420 show the current provided by the power pack 24 and the energy pack 22, respectively. In the first stage 405, the power pack 24 outputs the current (discharging) and is the sole source of power (see trace 415). The power pack 24 is discharged during the first stage 405 until the minimum SOC is reached.

Referring to box 425 in FIG. 5, the vertical axis Y2 indicates state of charge, while the horizontal axis T shows time. Trace 430 shows the state of charge of the energy pack 22, trace 435 shows the state of charge of the power pack 24, and trace 440 indicates the minimum SOC or threshold SOC of the power pack 24. As shown by trace 435, the state of charge for the power pack 24 continuously declines as it is consumed in the first stage 405, until the state of charge reaches the minimum SOC (at time T1).

When the SOC of the respective battery cells 20 in the power pack 24 reaches the minimum SOC, the power pack 24 is maintained at the minimum SOC (trace 440), and the energy from the energy pack 22 is employed for propulsion. The controller C is adapted to maintain the minimum SOC for the power pack 24 during the second stage 410 through the converter current or DC-DC current from the energy pack 22 to the power pack 24. The respective battery cells 20 in the power pack 24 are not ‘shut off’ in the second stage 410. The respective battery cells 20 in the power pack 24 may be actively used in the second stage 410 as long as the SOC of the power pack 24 is maintained at the minimum SOC.

Referring to box 445 in FIG. 5, the vertical axis Y3 indicates voltage, while the horizontal axis shows time T. Trace 450 shows the voltage of the energy pack 22, while trace 455 shows the voltage of the power pack 24. Referring to box 460 in FIG. 5, the vertical axis Y4 indicates current amplitude, while the horizontal axis T shows time. Trace 465 indicates the converter current or DC-DC current of the DC-DC converter 26, which is zero in the first stage 405 and is higher in the second stage 410 (indicated by portion 470, as current from the energy pack 22 is being utilized).

Referring to box 480 in FIG. 5, the vertical axis Y5 indicates temperature, while the horizontal axis T shows time. Trace 485 shows the variation of temperature in the battery module 14 through the first stage 405 and the second stage 410. Given a specific load current, the lower capacity of the power pack 24 results in a higher voltage decline or drop. The voltage drop for a given load current increases as the temperature decreases. When the temperature is relatively low, the voltage drop is significantly higher than in warmer temperatures, due to increased internal resistance. The output power of the power pack 24 is limited in this case to avoid exceeding voltage limits. The minimum SOC of the power pack 24 is higher in cold conditions than warm conditions, with the energy pack 22 being engaged earlier for the second stage. The controller C is adapted to determine a minimum SOC of the power pack 24 to avoid a sudden or rapid voltage drop.

Proceeding to block 208, the controller C is adapted to determine if exit conditions for exiting the first stage 405 (where the power pack 24 is the sole source of power) are satisfied. The controller C may be adapted to exit the first stage 405, and go into the second stage 410, when a predefined event of relatively high-power demand occurs. The event of relatively high-power demand may be varied based on the application at hand and may include the initial acceleration and/or take-off of the vehicle 16, the vehicle 16 hauling and/or towing a load. In other words, the energy pack 22 is called in when the power demand is higher than the maximum power of the power pack 24.

Also, per block 208, the controller C is adapted to update or adjust the minimum SOC for the power pack 24 in real-time. The voltage of the energy pack 22 changes depending on the state of charge of the energy pack 22. Accordingly, the minimum SOC is adjusted when the state of charge of the energy pack 22 changes.

Proceeding to block 210, operation of the vehicle 16 is controlled based on modulating the first stage 405 and the second stage 410 while meeting the torque demand of the vehicle 16 through the battery module 14. During operation, the terminal voltage of the respective battery cells 20 in the energy pack 22 is lower than the terminal voltage of the respective battery cells 20 in the power pack 24. In some embodiments, if the cells in the energy pack 22 are charging rate limited, the control strategy directs the regenerative power to the respective battery cells in the power pack 24.

Referring to FIG. 1, the controller C may be configured to receive and transmit wireless communication with a cloud unit 52, via the wireless network 50. The cloud unit 52 may include one or more servers hosted on the Internet to store, manage, and process data. The wireless network 50 of FIG. 1 may be a Wireless Local Area Network (LAN), a Wireless Metropolitan Area Networks (MAN), a Wireless Wide Area Network (WAN), WIFI, or Bluetooth™ connection.

In summary, the system 10 enables energy management of parallel dual-design battery module 14 based on real-time feedback. The respective battery cells 20 in the energy pack 22 generally deliver sustained and continuous current over a long duration, while the respective battery cells 20 in the power pack 24 generally deliver high current loads over a short duration at intermittent intervals. The controller C is adapted to determine a minimum SOC for the respective battery cells 20 in the power pack 24 such that a respective voltage of the power pack 24 is equal to the respective voltage of the energy pack 22. The system 10 extends the range of the vehicle 16 maximizes the life of the battery module 14.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 may be an integral portion of, or a separate module operatively connected to, other controllers of the vehicle 16. The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts shown in the FIG(S). illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for managing an energy storage device in a vehicle, the system comprising:
a battery module having an energy pack adapted to generate a first current, and a power pack connected in parallel to the energy pack;
at least one DC-DC (direct current to direct current) converter adapted to receive the first current from the energy pack, and transmit a DC-DC current to the power pack;
a controller having a processor and tangible, non-transitory memory on which instructions are recorded, execution of the instructions causing the controller to determine a minimum SOC (state of charge) for respective battery cells in the power pack, based in part on a plurality of parameters, such that a respective voltage of the power pack is equal to the respective voltage of the energy pack;
wherein the vehicle is adapted to undergo a first stage and a second stage, the energy pack and the power pack being adapted to concurrently provide power to the vehicle during the second stage;
wherein the power pack is discharged during the first stage until the minimum SOC is reached, the power pack being a sole power source for the vehicle during the first stage; and
wherein operation of the vehicle is controlled based in part on the minimum SOC, the controller being adapted to maintain the minimum SOC for the power pack during the second stage through the DC-DC current from the energy pack to the power pack.

2. The system of claim 1, wherein the power pack is adapted to deliver a load current for powering a load in the vehicle and the plurality of parameters includes an expected maximum value of the load current.

3. The system of claim 2, wherein the plurality of parameters includes a state of charge of the energy pack.

4. The system of claim 3, wherein the plurality of parameters includes a temperature of the battery module.

5. The system of claim 1, wherein the DC-DC converter includes an exclusive buck mode and an exclusive boost mode, the DC-DC converter operating in the exclusive boost mode when the respective battery cells in the energy pack are discharging, and the DC-DC converter operating in the exclusive buck mode when the respective battery cells in the energy pack are charging.

6. The system of claim 1, wherein a terminal voltage of the respective battery cells in the energy pack is lower than the terminal voltage of the respective battery cells in the power pack.

7. The system of claim 1, wherein the controller is adapted to exit the first stage when a predefined event of relatively high-power demand occurs.

8. The system of claim 1, wherein the energy pack and the power pack have different chemistries.

9. The system of claim 8, wherein the respective battery cells in the energy pack are at least partially composed of nickel, cobalt oxide, and manganese.

10. The system of claim 8, wherein the respective battery cells in the power pack are at least partially composed of lithium, iron, and phosphate.

11. A method for managing an energy storage device in a vehicle having a controller with a processor and tangible, non-transitory memory, the energy storage device having a battery module, the method comprising:
incorporating an energy pack and a power pack in the battery module, the energy pack and the power pack being connected in parallel;
generating a first current, via the energy pack;
adapting at least one DC-DC (direct current to direct current) converter to receive the first current from the energy pack, and transmit a DC-DC current to the power pack;
determining a minimum SOC (state of charge) for respective battery cells in the power pack, based in part on a plurality of parameters, such that a respective voltage of the power pack is equal to the respective voltage of the energy pack;
adapting the vehicle to undergo a first stage and a second stage, the energy pack and the power pack being adapted to concurrently provide power to the vehicle during the second stage;
discharging the power pack during the first stage until the minimum SOC is reached, the power pack being a sole power source for the vehicle during the first stage; and
controlling operation of the vehicle based in part on the minimum SOC, the controller being adapted to maintain the minimum SOC for the power pack during the second stage through the DC-DC current from the energy pack to the power pack.

12. The method of claim 11, further comprising:
incorporating respective battery cells composed of nickel, cobalt oxide, and manganese in the energy pack; and
incorporating the respective battery cells composed of lithium, iron, and phosphate in the power pack.

13. The method of claim 11, further comprising:
delivering a load current for powering a load in the vehicle, via the power pack, and including an expected maximum value of the load current in the plurality of parameters.

14. The method of claim 11, further comprising:
including a state of charge of the energy pack and a temperature of the battery module in the plurality of parameters.

15. The method of claim 11, further comprising:
incorporating an exclusive buck mode and an exclusive boost mode in the DC-DC converter; and
operating the DC-DC converter in the exclusive boost mode when the respective battery cells in the energy pack are discharging, and operating the DC-DC converter in the exclusive buck mode when the respective battery cells in the energy pack are charging.

16. The method of claim 11, further comprising:
setting a terminal voltage of the respective battery cells in the energy pack to be lower than the terminal voltage of the respective battery cells in the power pack.

17. The method of claim 11, further comprising:
exiting the first stage when a predefined event of relatively high-power demand occurs, via the controller.

18. A vehicle comprising:
a battery module having an energy pack adapted to generate a first current, and a power pack connected in parallel to the energy pack;
at least one DC-DC (direct current to direct current) converter adapted to receive the first current from the energy pack, and transmit a DC-DC current to the power pack;
a controller having a processor and tangible, non-transitory memory on which instructions are recorded, execution of the instructions causing the controller to determine a minimum SOC (state of charge) for respective battery cells in the power pack, based in part on a plurality of parameters, such that a respective voltage of the power pack is equal to the respective voltage of the energy pack;
wherein the plurality of parameters includes an expected maximum value of a load current, a state of charge of the energy pack, and a temperature of the battery module;
wherein the vehicle is adapted to undergo a first stage and a second stage, the energy pack and the power pack being adapted to concurrently provide power to the vehicle during the second stage;
wherein the power pack is discharged during the first stage until the minimum SOC is reached, the power pack being a sole power source for the vehicle during the first stage; and
wherein operation of the vehicle is controlled based in part on the minimum SOC, the controller being adapted to maintain the minimum SOC for the power pack during the second stage through the DC-DC current from the energy pack to the power pack.

19. The vehicle of claim 18, wherein the DC-DC converter includes an exclusive buck mode and an exclusive boost mode, the DC-DC converter operating in the exclusive boost mode when the respective battery cells in the energy pack are discharging, and the DC-DC converter operating in the exclusive buck mode when the respective battery cells in the energy pack are charging.

20. The vehicle of claim 18, wherein the controller is adapted to exit the first stage when a predefined event of relatively high-power demand occurs.
